(19) United States
(12) Patent Application Publication
(10) Pub. No.: US 2007/0265910 A1
(43) Pub. Date: Nov. 15, 2007

(54) ATTENTION MARKETPLACE

(76) Inventor: Kivin Varghese, Durham, NC (US)

Correspondence Address: PATENTBEST, 4600 ADELINE ST., #101, EMERYVILLE, CA, 94608, US

(21) Appl. No.: 11/382,616

(22) Filed: May 10, 2006

(51) Int. Cl. G06Q 30/00

(52) U.S. Cl. 705/14

(57) ABSTRACT

Methods and systems for advertising, and specifically, for creating and maintaining an attention marketplace are disclosed. In the attention marketplace, users are paid a price for paying attention to an advertisement, are presented with the advertisement, and are compensated according to the specified attention price if they paid attention to the advertisement. The attention price is either specified by the user or determined for the user based on user attributes, the nature of the advertisement, and the desires of the marketer and marketplace operator. If the price is determined for the user, the user's decision as to whether or not to view the advertisement is taken into account when determining a new attention price for the user.

### BACKGROUND OF THE INVENTION

1. Field of the Invention

The invention relates generally to advertising, and more specifically to methods and systems for creating, executing and maintaining a marketplace for attention.

2. Description of Related Art

For many years, the advertising industry has relied on a combination of different types of advertisements, including display advertisements, audio, video, and interactive commercials. Those forms of advertisements have come to pervade popular entertainment, from print media to radio to television, movies, and the World Wide Web. However, as advertisements have become more pervasive, consumer attention to advertisements has waned.

Unfortunately, the problem of waning attention continues to grow because of advances in technology and changes in entertainment forms and habits. Digital video recorders, for example, make it ever easier to skip or fast-forward through advertisements, and a plethora of cable and satellite entertainment programming appears to have fragmented audiences and decreased the average consumer's attention span.

Marketers continue to try to find new ways to capture consumer attention, and have begun to focus on the World Wide Web and other new media outlets including interactive TV advertising. However, advertising on the World Wide Web and in other new forms of media is still emerging. For example, conventional banner, flash, and video advertising on the World Wide Web is ubiquitous but its efficacy is unproven.

### SUMMARY OF THE INVENTION

One aspect of the invention relates to a method for advertising. The method comprises allowing a user to specify an attention price for paying attention to one or more advertisements, presenting the one or more advertisements to the user, and providing the user with compensation according to the attention price.

Another aspect of the invention relates to a method for advertising. The method comprises determining an attention price for the user and allowing the user to choose whether or not to view one or more advertisements in exchange for compensation according to the attention price. If the user chooses to view the advertisements, the method also comprises presenting the advertisements to the user and providing the user with compensation according to the attention price. Finally, the method comprises determining a new attention price based, at least in part, on whether or not the user chose to view the one or more advertisements in exchange for compensation according to the attention price.

A further aspect of the invention relates to an advertising system. The advertising system comprises an account module, a marketplace module, a delivery module, and a payment module. The account module collects user attributes and establishes user accounts. The marketplace module presents at least one appropriate advertisement and allows a user to specify an attention price for viewing the at least one appropriate advertisement. The delivery module delivers the advertisement to the user, and the payment module compensates the user for paying attention to the advertisement according to the attention price.

Yet another aspect of the invention relates to a method of advertising. The method comprises broadcasting an advertisement to one or more users. For at least one of the one or more users, the method further comprises determining an attention price or allowing a user to specify the attention price, confirming that the user has paid attention to the advertisement, and, if the user has paid attention to the advertisement, compensating the user according to the attention price.

Other aspects, features, and advantages of the invention are set forth in the description that follows.

### BRIEF DESCRIPTION OF THE DRAWINGS

The invention will be described with respect to the following drawing figures, in which like numerals represent like elements throughout the figures, and in which:

FIG. 1 is a general flow diagram illustrating the tasks involved in a method according to one embodiment of the invention;

FIG. 2 is an illustration of an exemplary advertisement selection and price specification screen that may be used in methods according to embodiments of the present invention;

FIG. 3 is an illustration of another exemplary advertisement selection and price specification screen that may be used in methods according to embodiments of the invention;

FIG. 4 is an illustration of a receipt ticket that may be used in some embodiments of the invention;

FIG. 5 is a general illustration of a system for creating and maintaining an attention marketplace according to an embodiment of the present invention;

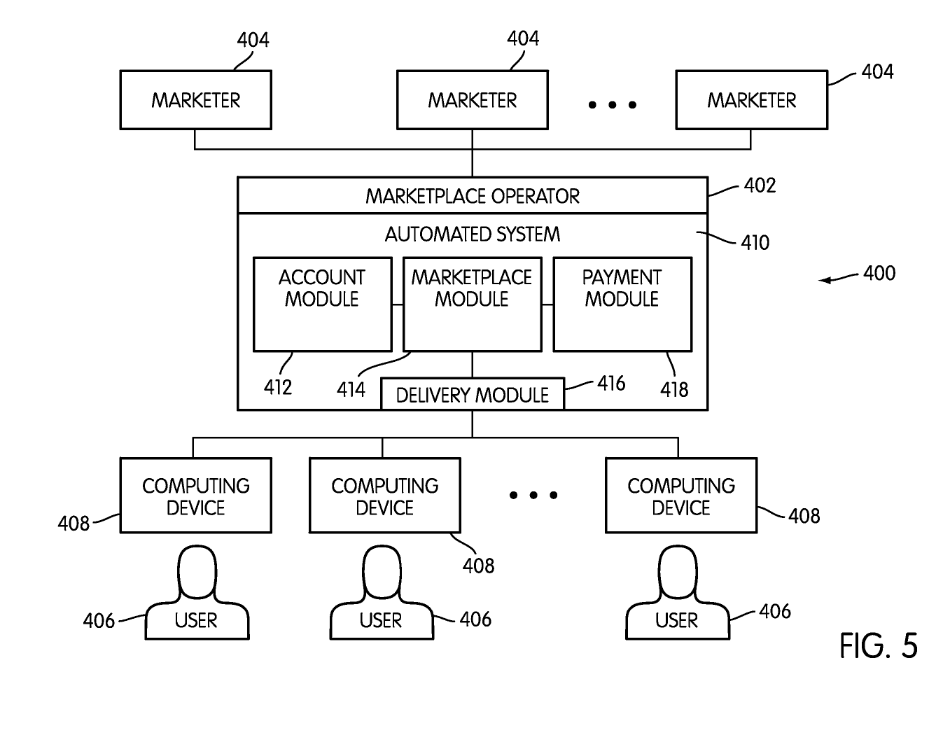

FIG. 6 is a general illustration of a system for creating and maintaining an attention marketplace according to another embodiment of the present invention;

FIG. 7 is an illustration of a new advertisement placement screen that may be used by a marketer to place an advertisement in methods according to the present invention;

FIG. 8 is a general flow diagram of a method according to another embodiment of the invention; and

FIG. 9 is an illustration of a broadcast advertisement with a tag.

### DETAILED DESCRIPTION

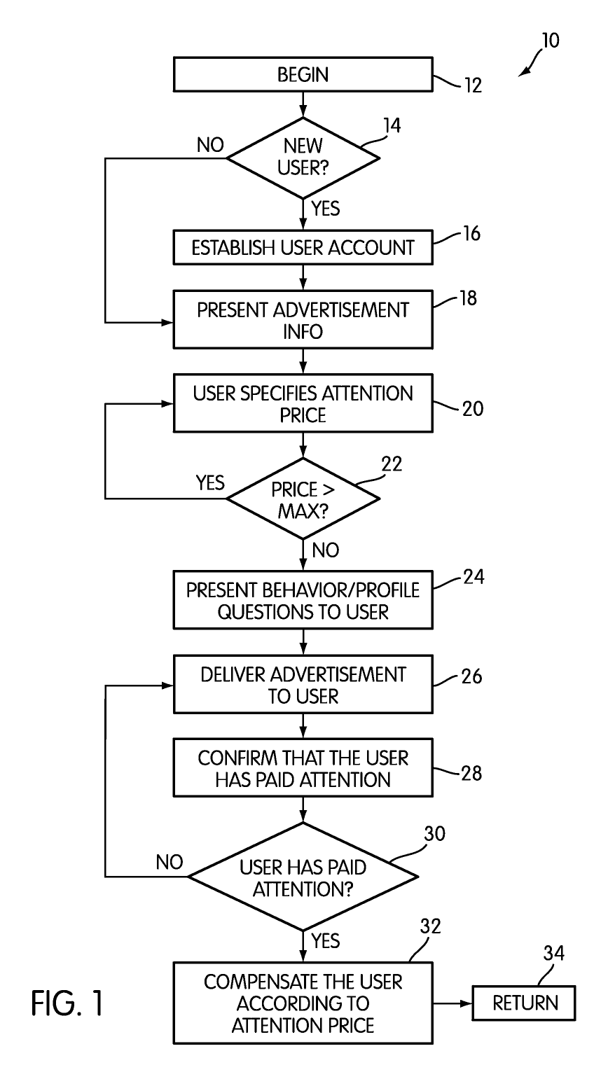

FIG. 1 is a general flow diagram illustrating the tasks involved in a method, indicated at 10, according to one embodiment of the invention. In general terms, method 10 is a method for advertising and, more specifically, for creating, executing, and maintaining an attention marketplace. In a general attention marketplace, users are compensated for watching advertisements. In the attention marketplace of method 10, users specify an attention price, also referred to in this specification as a demand price, for paying attention to an advertisement. The user is then given the advertisement to watch and is compensated for their time and attention according to the specified attention price.

Method 10 may be performed in a variety of ways, with or without the use of automated electronic systems to manage its tasks. Specific embodiments of systems that may be used to carry out method 10 will be described below in more detail. Some of the description of method 10 presented below may assume that decisions regarding method 10 are made by an automated system or systems, and that a user interfaces with the automated system or systems using a personal computing device connected to the automated system through a computing network, such as the Internet. Method 10 is particularly well suited for execution using the World Wide Web of the Internet.

The personal computing device used by the user may be any device capable of performing the functions attributed to it in this specification. Examples of personal computing devices include desktop and laptop personal computers, personal digital assistants (PDAs), cellular telephones, digital music and media players, televisions, and television set-top boxes.

Method 10 begins at 12 when a user uses a personal computing device to connect with the operator of method 10. The method then continues with task 14, a decision task. In task 14, if the user seeking to participate in method 10 is a new user (task 14:YES), method 10 continues with task 16, in which the user is asked to establish a new account.

When establishing an account in task 16, a user may be asked for a variety of different types of information. Generally, the information collected in order to establish a new account may be any combination of basic contact information, demographic information, psychographic information, and behavioral information. Demographic information includes location and vital statistics. Psychographic information refers to information that tends to indicate the social class and lifestyle of a user. Behavioral information refers to information on specific behaviors, such as spending, shopping, visiting, and/or website browsing behaviors and activity. The user might be asked any number of questions that the operator of method 10 desires; however, the number of questions asked of the new user and the range of information collected at the outset would generally be balanced against the possibility of alienating the user and driving him or her away. Some questions that the user is asked when establishing a new account may be designated as “required” while other questions may be designated as “optional.”

In some embodiments, users may be screened at the outset based on their contact information. For example, users may only be permitted to register and establish a new account in task 16 if they live in a particular place, have an e-mail address from a particular domain, such as the “.edu” domain, have a cellphone number, or somehow are able to verify their identity or personal characteristics (e.g., gender and age) in some other way. Certain other conventional technologies may also be used to screen users at the outset. For example, a user could be asked to take a CAPTCHA™ (Completely Automated Public Turing Test to Tell Computers and Humans Apart) to confirm that the user is a real person. Users might also be asked to agree to terms of service or a privacy policy.

Once a user account has been established in task 16, method 10 continues with task 18, in which the user is presented with information on available advertisements. Whether or not an advertisement is “available” for viewing by a particular user depends on such factors as whether the user in question has already seen and been compensated for viewing the advertisement and whether the advertisement is appropriate for the user. The appropriateness of any particular advertisement is generally determined by considering whether or not a marketer is targeting consumers like the user for that particular advertisement. For example, in most situations, it may not be the best use of a marketer's budget to pay a male to watch an advertisement for feminine hygiene products. Particular methods for matching users to advertisements will be described below in more detail.

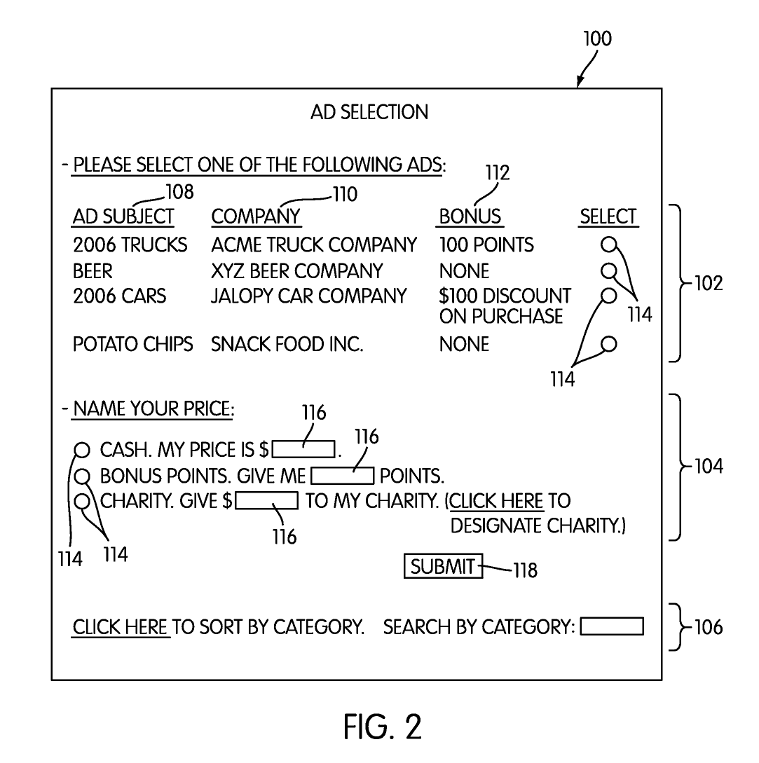

Task 18 and task 20, in which the user names his or her attention price, may be accomplished in a number of ways. FIG. 2 illustrates an exemplary advertisement selection and price screen 100 as viewed by a user performing tasks 18 and 20 of method 10. Screen 100 may be presented to the user using a web browser or another software application on his or her computing device.

Screen 100 includes advertisement selection portion 102 and price specification portion 104 and thus consolidates the two tasks 18, 20 of selecting an advertisement and naming a price into one screen for ease of presentation to the user; however, the two tasks 18, 20 may be presented and accomplished separately. In addition to the advertisement selection portion 102 and the price specification portion 104, screen 100 also includes a sort and search portion 106, which will be explained in greater detail below.

In the illustrated embodiment, screen 100 displays the subject of each advertisement 108, the company 110, a set of bonus indications 112, and a button 114 allowing the user to select the advertisement for viewing. In a screen like screen 100, if the name of the company or marketer offering the advertisement is not necessarily familiar to the average user, the product brand name or names may be included in the company column 110 instead of the company name. More generally, in identifying advertisements for user selection, method 10 may offer any sort of available information on the advertisements to the user, with the goal being to allow the user to decide whether or not he or she wants to view the particular advertisement.

The bonus indications 112 shown in screen 100 relate to the compensation offered the user in exchange for paying attention to the advertisement. Compensation, as the term is used in this specification, refers to anything of value offered to the user in exchange for the user's attention. The types of compensation offered to the user may vary with the particular embodiment of the invention, with the desires and budget of the marketer, and with certain other factors, such as the length of the advertisement and the desirability and past behaviors or profile of the user. Generally speaking, two types of compensation may be used in any combination in method 10 and in other methods according to embodiments of the invention: monetary compensation and promotional compensation.

The term monetary compensation generally refers to negotiable currency or its equivalent in electronic form, denominated in U.S. dollars or in the currency of another country or currency-issuing authority (other examples of currency include Canadian and Australian dollars, Euros, and Japanese Yen, to name a few). The term promotional compensation refers to other forms of compensation, which are usually tied to a particular product or service. Forms of promotional compensation may include product discounts, coupons, incentives, sweepstakes entries, free products, free content (television shows, music, video clips, articles, etc.), charitable donations made on behalf of the user, and “bonus points” or other credits that are redeemable through a particular vendor or vendors.

As was described above, in method 10, a user is permitted to name his or her attention price for paying attention to an advertisement. However, in most embodiments, the manner of compensation is limited in some way as a matter of practicality so that the user cannot, for example, name a price that the operator of method 10 is not prepared or is not equipped to pay. For example, using screen 100, the user is allowed to select one of three forms of compensation in portion 104: cash, bonus points redeemable through the operator of method 10, or a cash donation to charity.

For each particular advertisement, regardless of the attention price that the user specifies, there also may be an additional monetary or promotional form of compensation. For example, according to screen 100, one car company is offering a $100 discount to the user if he or she purchases a car after he or she views an advertisement entitled “2006 cars.” As the foregoing example illustrates, additional promotional compensation may be used to encourage the user to actually buy or use the products or services featured in their respective advertisements. However, additional or bonus compensation is not required: two of the four advertisements illustrated in screen 100 do not offer any additional compensation; the other advertisement offers 100 “bonus points” redeemable through the operator of method 10 for various goods and services.

In order to perform task 20 and specify an attention price, the user selects an advertisement in the advertisement selection portion 102 by clicking on the button 114 next to the advertisement and then specifying his or her price in price specification portion 104. Using screen 100, this would be done by clicking a button 114 next to one of the compensation options (in this case, cash, bonus points, or a charitable contribution to a user-designated charity), and then specifying a particular attention price by entering it into the corresponding data entry field 116 for the selected compensation option. Once a compensation option has been chosen and a particular attention price entered into a corresponding one of the data entry fields 116, the user may submit the request for processing by selecting the submit button 118.

As was noted above, the forms of compensation available for each particular advertisement may be limited in type, and screen 100 may be configured or dynamically reconfigured to reflect those limitations. For example, if the user selected a particular advertisement for which no cash or charity donation compensation was available, those two options could be “grayed out” or made non-selectable in price specification portion 104.

The final portion of screen 100 is the search portion 106. As depicted in FIG. 2, screen 100 presents advertisements appropriate for the user in no particular order. The appropriate advertisements presented to the user in screen 100 may be assumed to be all available advertisements that match at least a portion of the user's known interests. It may be assumed, for example, that the user of screen 100 is interested in a new vehicle. Methods for determining the user's interests will be described in more detail below.

However, presenting all appropriate advertisements to the user at once may not be the best or most expedient manner of presentation in all embodiments. The layout of screen 100 assumes that the user's primary motivation is to earn compensation by viewing advertisements, and that the user is less focused on the precise nature of those advertisements or the products advertised.

Therefore, if the user is interested in particular types of products, search portion 106 allows the user to use method 10 as an information resource, by searching for particular subjects or categories of information in which the user is interested. In this way, the user can use method 10 to educate him or herself and to gather product information for particular topics and products. In screen 100, search portion 106 also allows the user to sort the advertisements by category for easier perusal of the list.

Using screen 100, the user is presented with a substantial amount of information about each advertisement when choosing an advertisement to view in task 18 of method 10 and in specifying a price in task 20. However, in some embodiments, it may be more advantageous to withhold the name of the company or marketer and to present only a general description of the subject matter. That is because providing the user with very little information beforehand may help to ensure that the user is not unduly biased against particular advertisements and if any questions are asked prior to viewing the ad (like brand preferences or usage behavior for example), those answers will not be biased.

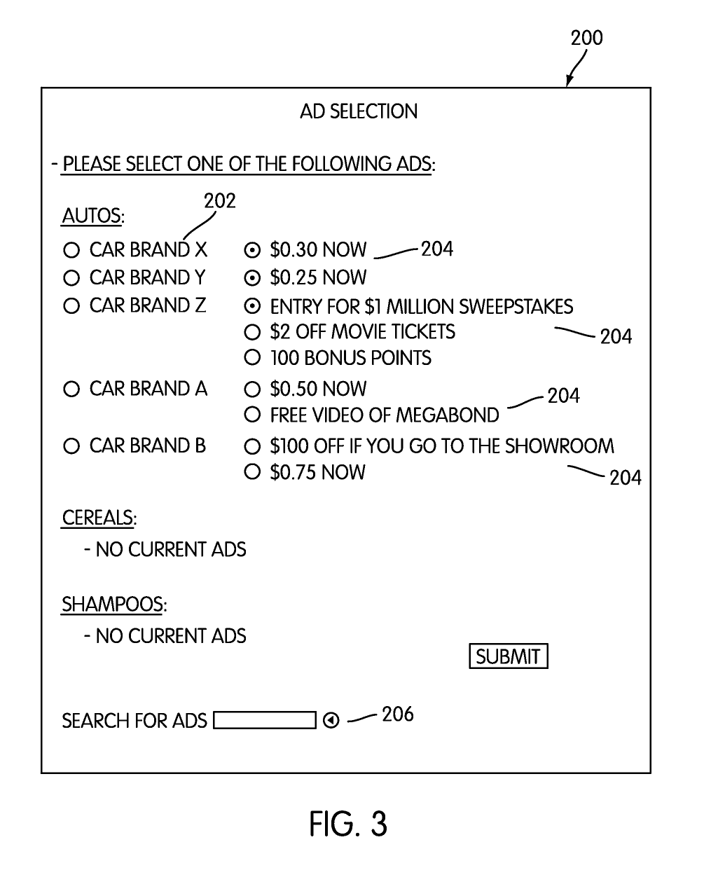

FIG. 3 illustrates an advertisement selection and price screen 200 according to another embodiment of the invention. Like screen 100, screen 200 is used in the performance of tasks 18 and 20 of method 10. Screen 200 includes an advertisement selection portion 202 and a plurality of price specification portions 204, one for each advertisement featured in advertisement selection portion 202. Screen 200 also includes a search portion 206.

Although screen 100 and screen 200 are fundamentally similar, there are several differences between them. For one, using screen 200, the user is presented only with very generic information about each advertisement (e.g., “Car Brand X,” “Car Brand Y,” etc.) in order to avoid biasing the user against any particular advertisement. In addition, the advertisements are organized by category. For example, as illustrated in screen 200, five advertisements are available in the “autos” category, and none in the “cereals” or “shampoos” categories.

The manner of allowing a user to specify an attention price is slightly different using screen 200 as compared with the manner of screen 100. In contrast to screen 100, in screen 200, a price specification portion 204 is adjacent to each advertisement, each price specification portion 204 listing one or more possible attention prices that the user is permitted to choose between. Thus, instead of being given an open opportunity to specify an attention price, the user with screen 200 specifies one of several attention price alternatives.

Screen 200 also illustrates that, in some cases, advertisements with only one possible option for attention price may be included in the selection list. In screen 200, car brands X and Y have only one attention price option each. This provides versatility in situations where some marketers may want to allow a user to specify an attention price and others may not.

Of course, the particular screen layouts and the type and extent of information presented in each screen may be adapted to fit the needs of the operator of method 10. Any layout or method of presentation of information that allows the user to accomplish the tasks of method 10 may be used. In particular, if the user's personal computing device has a small screen, limited processing power, or other limitations, as would exist with a cellular telephone or PDA, the information presented in screens 100 and 200 may be presented in some other fashion.

Although not shown in the illustrated screens 100 and 200, several advertisements may be bundled together so that the user specifies or is given a single attention price for watching all of the bundled advertisements.

As shown in FIG. 1, once appropriate advertisements are presented in task 18 of method 10 and an attention price has been specified in task 20, method 10 continues with task 22, in which the automated system or the operator of method 10 decides whether the user's specified attention price is acceptable.

At some point in a method of operating an attention marketplace such as method 10, it will generally be necessary to decide what user-specified attention prices or range of attention prices is acceptable to the marketer or to the operator of the method. However, there are several ways of performing this task, and several points in a method like method 10 at which it could be performed.

Assuming that the user has used screen 100 or another method of specifying an attention price that allows free-form entry, task 22 would typically involve at least checking the user's specified price against some predetermined maximum price that the marketer is willing to pay. Methods and considerations for setting that maximum price, which may also be referred to as a supply price, will be described in more detail below. However, in the context of method 10 and the description here, it should be understood that the supply price need not be a single price; it may vary depending on the user and how much the marketer wants a user with particular attributes to view an advertisement. Different supply prices may be set for different users.

The supply price may be dictated either directly or indirectly by the marketer. In some situations, the marketer may specify the maximum price to be paid for each user, while in other situations, a marketer may provide a third-party operator of method 10 with an overall budget and allow the third-party operator to define the maximum supply price for each user.

When method 10 uses screen 200 or a similar fixed-option manner of allowing a user to specify an attention price, all of the options from which the user may select are typically acceptable in the context of task 22—the decision that those particular attention price options will be offered has typically been made at some prior point. For example, the decision could be made prior to the execution of method 10 to offer each user the same attention price options, or to offer users with certain attributes certain attention price options (presumably with users having attributes that are more attractive to the marketer being given more valuable attention price options). Alternatively, the decision of what attention price options to offer could be made just prior to task 18 of method 10. In either of those cases, when the user is presented with fixed attention price options, task 22 may entail making sure that the attention price option chosen by the user is still available at the time of selection, particularly if method 10 is being carried out in a high-volume environment with many simultaneous users.

If the specified attention price is not acceptable (task 22:NO), method 10 returns to task 20 and asks the user to specify a new attention price. This may be done, for example, by returning to screen 100 or 200 and informing the user that “Your attention price was not accepted or was not available. Please specify another attention price.” with an opportunity to specify another attention price.

If the specified attention price is acceptable (task 22:YES), method 10 continues with task 24, an optional task, in which the user is presented with a certain number of behavioral or profile questions. In some embodiments, it may be preferable or advantageous to proceed directly to the presentation of the advertisement or advertisements; however, asking questions about the user's attitudes or behaviors allows the marketer to establish what the user's attitudes and behaviors are before viewing the advertisement. This is also one of a number of ways to build the user's profile—the general bank of information available about a particular user that can be used to target advertisements and to decide how high of an attention price should be paid to the user for his or her attention. For example, if the advertisement about to be viewed is directed to a car, questions such as the following may be appropriate pre-advertisement questions to be presented in task 24:

What kind of car do you currently drive?

How long have you had your current car?

How soon are you planning on replacing your current car?

What other types of cars have you driven or are you considering?

The answers to pre-advertisement questions may be stored individually in the user's profile and/or used to produce composite statistics. They may also be used as indicators of user interests to be considered with respect to task 18 in deciding which advertisements are appropriate for presentation to any particular user. In general, user profile information can be aggregated, analyzed, and used to determine what kind of inducements, promotions, or other factors can increase interest. For example, user profile information in the aggregate may demonstrate that drinkers of a particular brand of cola who play video games four times per week and eat at a particular Mexican food franchise are particularly receptive to commercials for another brand of soda. Therefore, advertisements for that other brand of soda would be appropriate for a user with those characteristics.

If task 24 is performed and the user is presented with pre-advertisement questions, once the user has answered the questions, method 10 continues with task 26, in which the user is presented with the advertisement or advertisements for which he or she specified an attention price.

As the term is used here, “advertisement” refers to any sort of presentation intended to inform the user of a particular product or service or to influence user behavior in some way. Examples of advertisements include product advertisements, service advertisements, political advertisements, and informational pages with data, imagery, or other information about the product/service. Advertisements may be presented in different formats. Examples of advertisement formats include videos, static display ads, spoken word and musical advertisements, and interactive games, questionnaires, and presentations.

Advertisements may be presented to the user in any appropriate format, depending on the manner in which method 10 is executed. If, for example, method 10 is carried out over the Internet with users connected to a central automated system by personal computing devices, then the advertisements may be delivered in any format and in any size or resolution compatible with the personal computing devices. For example, video advertisements may be stored and presented to the user using MPEG format, Windows Media Player format, or Quicktime format, to name a few. Audio advertisements may be presented in, for example, MP3, AAC, Windows Media Player or RealAudio formats. Static display advertisements may use any image format compatible with the user's personal computing device, including GIF format, JPEG format, PNG format, or TIFF format. Interactive games may be programmed in any appropriate language and presented in any compatible format including Java, Javascript/HTML, and Flash. Advertisements may also be tailored for special or adaptive delivery methods. For example, an advertisement could be tailored for delivery in large type, in audio format, or in Braille, if required.

One decision in implementing method 10 is whether to provide the advertisements to the user in a permanently downloadable form, or whether to provide only temporary or partial access to the advertisements. In some embodiments, it may be preferable to provide only limited or one-time access to the advertisement or advertisement, for example, by allowing the user to access it by a streaming file transfer protocol, rather than by providing it outright as a single file download. Streaming an advertisement, for example, minimizes space demands on the user's personal computing device and may allow an operator of method 10 better control over how many users are viewing a particular advertisement. If desired, rights management or other similar technologies may be applied to the advertisement or advertisements to control their distribution.

After the user has been presented with the advertisements, method 10 continues with task 28, an optional but advantageous task, in which the operator of method 10 confirms that the user has paid attention to the advertisement or advertisements. Confirming that the user has paid attention to the advertisements may involve slightly different actions, depending on the embodiment. In the simplest embodiments, confirming that the user has paid attention to the advertisement may comprise simply checking that the advertisement reached the user's personal computing device.

However, more advantageously, confirming that the user has paid attention to the advertisements comprises eliciting some response from the user to confirm that the user has paid attention to the advertisement. One way in which this may be done is by asking the user a question or a series of questions that are focused on the content of the advertisement and can only be answered correctly if the user has actually paid attention to the advertisement or advertisements. For example, if an advertisement indicates that its product is “four times better than the competitor,” the user may be asked how many times better the product is than the competitor. If the advertisement had a particular tagline, the user might be asked what the tagline was. Generally, questions will reinforce the key message or messages of the advertisement. Questions could be written by the marketer, by the operator of method 10, by the creator of the advertisement, or by some other party. Questions may be humorous, constructed as a game, or paired with an audiovisual display to engage the user.

In some embodiments, confirming that the user has paid attention to the advertisement or advertisement in task 28 may comprise forcing the user to perform some task that requires the user to be paying attention to the personal computing device where the advertisement is playing—like clicking on a particular area of the screen or answering a question—while the advertisement is playing. However, in most embodiments, it may be more advantageous to use questions that focus on the content of the advertisement because those types of questions act to reinforce the message conveyed by the advertisement.

Questions need not be asked only after an advertisement has been presented. Depending on the desires of the marketer or the operator of method 10, it may be advantageous to ask questions about a particular advertisement some time after the advertisement has been viewed, in order to gauge whether or not the user has actually retained the message conveyed by the advertisement. For example, questions about a particular advertisement or group of advertisements could be presented a few days or a week later, along with the kind of profile and behavior questions typically asked in task 24 prior to viewing another advertisement. Alternatively, additional questions about a particular advertisement could be presented when a user first logs in or identifies him or herself, prior to task 18. Answers to the questions may be recorded so that the operator of method 10 can provide the marketer with information on how well particular messages have been retained.

Task 30 of method 10 is a decision task in which the operator of method 10 or the automated system determines whether the user has paid attention. If questions are asked in task 28, then task 30 may comprise a process of checking the user's answers against the correct answers to the questions. Typically, a user would need to answer a certain predetermined number or percentage of questions correctly (e.g., 80%) in order to confirm that he or she has paid attention to the advertisement and deserves compensation. If the user has paid attention (task 30:YES), method 10 continues with task 32; if the user has not paid attention, as indicated by not answering one or more of the questions correctly (task 30:NO), method 10 may return to task 26 and present the user with the advertisement again. A user may be given a set number of chances (e.g., two or three) to view the advertisement and answer the questions correctly before he or she is denied compensation for that advertisement and either blocked or returned to some other point in method 10, such as task 18. If the user repeatedly fails to pay attention to advertisements, his or her account may be blocked or cancelled and he or she may be barred from further participation, or the payouts will decrease for this participant.

In task 32, the user is compensated according to the user's specified attention price. Note that the user is not necessarily given the specified attention price outright. For example, in some circumstances, the operator of method 10 may decide to provide more compensation as a bonus or for some other reason (e.g., every 100^{th} user is provided with an additional 10% bonus). Moreover, favorable actions in response to optional questions or obligations may merit more compensation. If, for example, the user was presented with optional behavioral questions in task 24 and chose to answer them, he or she could also be given a bonus, with more bonus compensation for users who showed favorable traits in response to those questions. If the user answers a survey or set of questions presented some time after the original advertisement, he or she may be given additional compensation.

However, other factors may be taken into account, and the user may be paid less than the specified attention price in some circumstances. For example, if the user answered less than all of the questions correctly in task 28, he or she could be provided with proportionally less compensation. The same might apply if the user required several iterations or tries to answer the questions correctly. In some circumstances, as will be explained below, a user may also be required to take additional actions after viewing an advertisement, such as clicking through to a vendor's site or visiting a showroom. If the user does not take these additional actions, in some embodiments, the portion of the attention price that the user is paid may decrease until they actually take the additional actions. Additionally, they may be paid only a portion of the specified attention price until they take the additional actions, at which point they may be paid the rest of the specified attention price.

More generally, in task 32, the user may be provided with any amount of compensation, so long as the user's specified attention price is taken into account and the amount of compensation is not selected entirely arbitrarily.

Typically, the operator of method 10 would maintain an account balance for each user along with his or her other profile information. Compensation may be transferred to the user only at intervals, or only under certain conditions. For example, compensation might be transferred to the user only once a month, or only if the user's account balance reaches a threshold balance, e.g., $5.

Financial transactions may occur using any means deemed desirable by the operator of method 10. Appropriate means for conducting financial transactions include automated clearing house (ACH) deposits to a user's personal accounts, credits to a user's credit card, and third party payment services, such as PAYPAL. Payment may also be made in the form of credits for mobile phone minutes, discounts off the monthly cable bill, free gasoline, or media content. Non-monetary or promotional compensation may be distributed by direct arrangement with the provider of the product or service (e.g., free cell phone minutes are credited directly to the user's cell phone account), or by means of discount codes or coupons recognizable by the provider of the product or service. For example, if the promotional compensation is a store gift certificate, it may be distributed in the form of a code recognizable by the store, or offered as a paper coupon with a bar code readable by the store, or offered as a credit to be paid at the store using a mobile device. Any conventional anti-tampering methods may be used to secure promotional compensation codes or certificates from duplication or fraud.

After compensation is awarded, method 10 concludes and returns at 34.

The foregoing described a single iteration of method 10 for a single user. In a service based on method 10, a user may be permitted to repeat the method any number of times. If the user is permitted to repeat the method any number of times, screens such as screen 100 and screen 200 may also include information like the user's account balance.

Although the user may be permitted to repeat the method any number of times, it may be advantageous to limit the number of advertisements that the user can view at any one time, so as to encourage the user to remember and act on the advertisements that he or she has seen. For example, the user may be limited to 25-30 advertisements per day, so as to improve the chances that he or she will remember those advertisements. However, the overall goal of method 10 is to reach users with advertising so that they retain and respond to that advertising. Therefore, if it can be shown that users retain what they are presented with in method 10, there may be no limits on the number of advertisements that a user is permitted to view in a particular time period, and the number shown to a particular user may be customized based on their retention and action information—for example, the participant who acts more often (purchases, visits, etc) and retains more information after a period of time, may be entitled to view more messages than a participant who doesn't act as much, and doesn't recall as many messages after a certain period of time

Method 10 or any portion of method 10 may be embodied in machine-readable instructions interoperable with a machine to perform the tasks described above. For example, method 10 could be embodied in software code to be executed on one or more automated systems.

Method 10 and other methods according to embodiments of the invention may also be used to tie together Internet marketing and marketing in the brick-and-mortar world. For example, in order to remain an active user of method 10 and to keep receiving compensation, a user may need to prove that he or she has actually purchased some of the products or services for which he or she has viewed advertisements, or has taken other actions favorable to the respective marketers.

As one example, assume that a user chose to view advertisements for cars in task 18. The description above noted situations in which compensation or additional bonus compensation may be used to motivate a user to purchase a product or take additional steps. For example, Car Brand B in screen 200 offered “$100 off if you go to the showroom.” After the user purchased the car at the showroom, he or she could be given a special code that is recognizable to the operator of method 10 and could be provided to the operator of method 10 to confirm the user's actions.

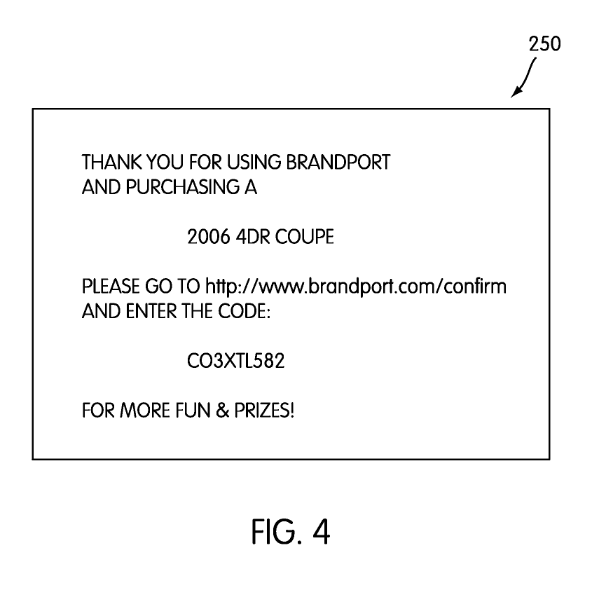

FIG. 4 is an illustration of an exemplary receipt ticket, generally indicated at 250. A receipt ticket such as receipt ticket 250 would typically be given after a purchase and might be included in the user's printed receipt of the transaction. As shown, the receipt ticket 250 includes a code (“CD3XTL582”) and instructs the user to go to a location controlled by the operator of method 10 (“http://www.brandport.com/confirm”) in order to enter the code.

The operator of method 10 may use receipt tickets 250 and the resulting confirmation of the user's favorable actions for several purposes. For example, a certain number of purchases or a certain magnitude of goods purchased may be required over a specified period of time in order for a user to continue using method 10. Receipt tickets 250 may also be used in determining the user's interests and in awarding bonus compensation of various forms. For example, if a user enters a code from a receipt ticket 250 to indicate that he or she purchased a particular product, that action is a good indicator that the user prefers or is interested in the particular product. Finally, users who enter in a predetermined number of codes from receipt tickets 250 over and above a level necessary to maintain membership might be offered extra compensation.

The foregoing description presented an attention marketplace method largely from the perspective of the user. FIG. 4 is a schematic illustration of the elements of a system, generally indicated at 400, that may be used in carrying out methods such as method 10. In FIG. 4, a marketplace operator 402 is at the heart of the system 400. The marketplace operator 402 acts as a middleman between a number of marketers 404 and a number of users 406, each of the users 406 typically interfacing with the marketplace operator 402 through their own personal computing device 408.

The term marketer, as used in this specification, includes anyone with a product or service that they desire to market to users. Marketers include manufacturing and service companies as well as their agents, advertising agencies, and other associated entities to whom marketing duties may be delegated or with whom those duties may be shared. In some embodiments, a marketer may be an individual person with a product or service to sell.

In alternative embodiments, a marketer, such as a large company or an advertising agency, may choose to run their own attention marketplace; however, in system 400, the marketplace operator 402 collects and aggregates advertisements from several marketers 404. Although method 10 and other methods according to embodiments of the invention may be carried out without the benefit of automated systems, in system 400, the marketplace operator 402 has an automated system 410 that is responsible for carrying out many of the functions and making many of the decisions ascribed to the marketplace operator 402, including those functions and decisions set forth above in the context of method 10.

The functions of the automated system 410 of the marketplace operator generally fall into four categories or modules, which are illustrated separately in FIG. 4:
(1) gathering account information from new users and maintaining account status and balance information for each user (account module 412);
(2) collecting advertisement information, matching users with appropriate advertisements and marketers, allowing a user to specify an attention price and a marketer to specify a supply price, checking a user's specified attention price against a marketer's maximum supply price, and verifying that a user has paid attention to an advertisement (marketplace module 414);
(3) delivering content to the user (delivery module 416); and
(4) compensating a user according to the attention price (payment module 418).
   The functions ascribed to the various modules and the nature of the modules may be different in different embodiments.

The account module 412 is the module responsible for gathering and holding user information and for providing the information used to match marketers with users and to determine which advertisements are appropriate for which users. The account module 412 would, for example, collect the information generated in response to screen 100 or screen 200, and any demographic, psychographic, or behavioral information gathered as a result of the questions presented in tasks 24 and 28 of method 10, as well as any other information known about the user. That information would be stored in one or more appropriate databases accessible by the account module 412, and, as needed, by other modules.

In some embodiments, user information may be imported into the account module 412 or into other portions of the automated system 402 from third party sources. For example, a consumer credit report may be imported into account module 412. Other examples of user information that may be imported into the account module 412 include demographic, psychographic or behavioral information from other sources and financial transactional information, such as a user's credit card spending activity, grocery purchase activity and history. In general, some or all user activity in system 400 would be logged, although the degree to which that information is used to determine user behaviors may vary from embodiment to embodiment.

Ultimately, through the account module 412, the marketplace operator 402 has access to a number of users, all of whom are potential consumers. By running an attention marketplace, the marketplace operator 402 gathers increasing amounts of information on the users 406. Therefore, the marketplace operator 402 can offer the marketers 404 a valuable commodity—access to a group of users 406 with known characteristics and behaviors whose attention to advertisements is guaranteed. In order to access that commodity and reach the users, the marketers 404 offer both the users 406 and the marketplace operator 402 compensation.

Once an advertisement has been selected by the user and an acceptable attention price specified, the delivery module 416 is generally responsible for delivering it to the user. This typically includes the task of selecting an appropriate format for the advertisement, allowing streaming or whole download of the advertisement, and may also include some of the tasks involved in questioning the user to verify attention.

The marketplace module 414 is generally responsible for the basic functions and operations needed to manage the attention marketplace. Its functions may be further subdivided, if necessary, and are generally the types of functions described above with respect to method 10.

Assuming that the user pays attention to the advertisement, the payment module is then responsible for compensating the user according to the specified attention price, including any credit card, ACH, or third party monetary transfers that may be necessary. The payment module may also be responsible for the creation and management of promotional compensation, and for generating codes used in receipt tickets 250.

In systems and methods according to embodiments of the invention, the operator of system 400 may interface directly or by non-automated means with marketers 404 to receive advertising, to determine and set what sort of users the marketer 404 wishes to reach with the advertising, and to determine the total budget and/or the maximum supply price for each user or type of user.

A marketer 404 may be able to specify any demographic, psychographic, or behavioral user attribute. For example, a marketer 404 in the sporting goods industry might specify that they wish their advertisement for a camping tent to reach male and female users, ages 18-34, who are interested in outdoor activities, and have purchased some form of outdoor recreational equipment in the last six months. The marketer might define a tiered supply price depending on the user's attributes. For example, a marketer 404 might be willing to pay up to $0.20 per user view for a user in the specified age range, up $0.40 per view for a user in the specified age range who was interested in outdoor activities, and up to $0.75 per view for a consumer who met all of the specified user attributes.

Alternatively, a marketer 404 might define those desirable user attributes and pay the marketplace operator 402 a fixed amount, such as $10,000 to reach at least 1,000 users with at least some of the desirable attributes and leave the precise decisions about supply price to the marketplace operator. In this context, the marketer 404 specifies a supply price insofar as the marketer 404 provides some guidance to the marketplace operator 402 as to the magnitude of the maximum supply price for each user.

Depending on the embodiment, the marketplace operator 402 may charge a fixed fee for its services, or it may take a commission on each user with the desirable attributes who is reached. For example, if the maximum supply price that the marketer 404 is willing to pay is $0.75 for a user matching all of its desirable attributes, the marketer may set the maximum supply price for that user as $0.60 and take $0.15 as a commission. Other financial arrangements between the marketers 404 and the marketplace operator 402 may be made. What a marketer pays may be de-linked or graduated; as one example, a marketer may pay a base of $0.30 per user for a particular group of users, plus $0.05 per question asked of those users, plus $0.10 per feedback question with analysis of the user's responses, plus $0.10 per click for users who clicked through using a direct response link or took some action after viewing the advertisement. If payment is graduated, the marketplace operator 402 may take that into account when setting the supply price.

Thus, in the context of a method such as method 10, matching a user to an advertisement and determining which advertisements are appropriate for a user to see and bid on would generally comprise matching not only an attention or demand price to a supply price, but also matching the attributes of the user 406 with the desired user attributes specified by the marketer 404.

In some embodiments, the marketplace module 414 of the automated system 410 may provide marketers 404 with an interactive interface for use in uploading advertisements and specifying desired user attributes. Using the interactive interface, marketers 404 may create an account, upload advertisement materials (e.g., images, audio, video, Flash), set a budget, set their target users, set their maximum supply price per view of the advertisement set their direct response requirements, input or provide questions related to the advertisement for the users. Marketers 404 may also log into the interactive interface to check the status of an advertisement campaign and to receive analysis and statistical information. For example, marketers 404 may be provided with the number of users reached, the budget status, user answers to advertisement or profile questions, additional actions taken by the users in response to the advertisements, user feedback given in response to a particular advertisement, recommended additional targeting criteria for future ad campaigns, analysis of past campaigns, benchmark statistics for the marketer's industry, and response to the present campaign as compared with past or concurrent advertisement campaigns. Methods for compiling these sorts of statistics are known in the art, and any appropriate statistical methods may be used in embodiments of the invention.

Table 1 below summarizes the flow of information and compensation in system 400 in one exemplary embodiment.

TABLE 1
Information and compensation flows in system 400.

| User | | Marketer | |
|---|---|---|---|
| To Marketplace | From Marketplace | To Marketplace | From Marketplace |
| Operator | Operator | Operator | Operator |
| Demographic data | Appropriate | Desired user | Statistics or |
| Behavioral data | advertisements | attributes | information on the |
| Psychographic | for the user | | number of users |
| data | | | reached and their |
| Selected | | Advertisements | attributes |
| advertisements | | | |
| Specified | Approval or | Specified supply | Statistics or |
| attention/demand | disapproval based | price(s)/specified | information on |
| prices | on supply prices | budget for supply | advertisement |
| | | prices or campaign | popularity and |
| Advertisement | Compensation | Questions or other | advertisement |
| question responses | according to | attention-confirming | retention over time, |
| Survey question | attention price, | materials | benchmark statistics |
| responses | bonus | | by industry, |
| Response ticket | compensation, | | comparisons with |
| codes | incentives, and | | past or concurrent |
| | continued | | advertisements |
| | membership | | |

Most of the information and compensation flows shown in Table 1 were described in detail above. As shown in Table 1, the marketplace operator 402 may provide the marketers 404 with feedback, including statistics or information on the number of users reached and their attributes, statistics or information on advertisement popularity, and statistics on advertisement retention over time. The type and nature of the feedback given by the marketplace operator 402 to the marketers 404 will vary with the embodiment and the sorts of questions and surveys presented to the users. For example, a measure of advertisement retention over time may not be provided unless the marketplace operator 402 asks questions about a particular advertisement at regular time intervals after the user has viewed the advertisement. Methods of performing these sorts of tasks were described above with respect to method 10.

In method 10 and systems like system 400, there is no requirement that all the compensation for paying attention to a particular advertisement come from a single marketer 404, although it may be advantageous in some embodiments in order to encourage users to actually purchase the goods or services whose advertisements they are viewing. However, in other embodiments, a marketplace operator 402 may pool monetary and promotional compensation from several marketers 404 in offering it to the users 406. The “bonus points” described above are a good example of this. The compensation offered with the accumulation of predetermined numbers of bonus points may include compensation from several marketers 404.

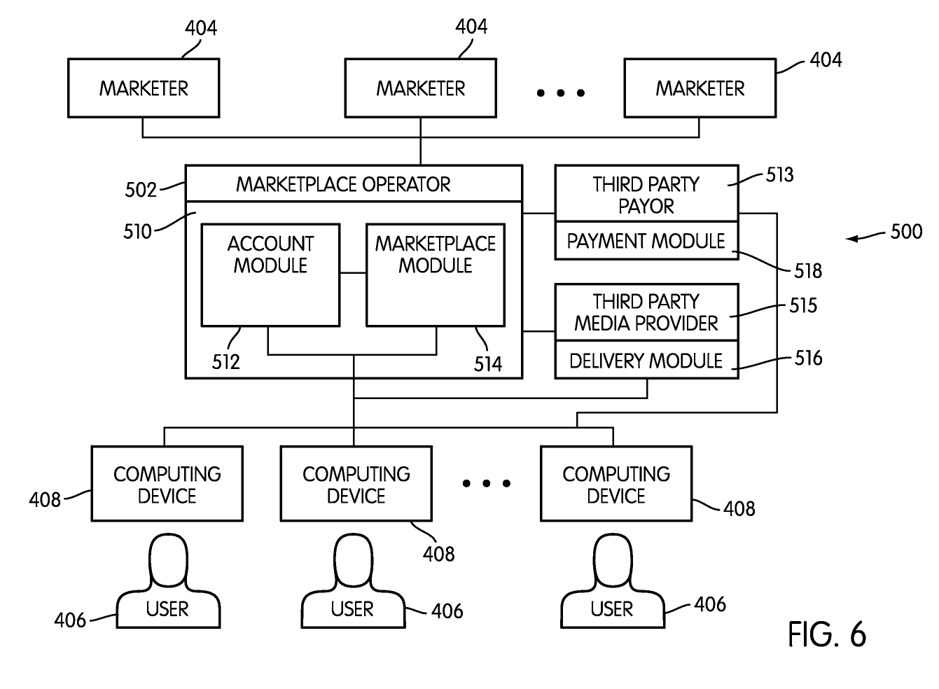

System 400 illustrates an embodiment in which the account module 412, the marketplace module 414, the delivery module 416, and the payment module 418 are all parts of the marketplace operator's own automated system 410. However, this need not be the case in all embodiments. FIG. 6 illustrates a system 500 in which the marketplace operator 502 does not directly manage the delivery module 516 or the payment module 518. Instead, the marketplace operator 502 has only an account module 512 and a marketplace module 514 as parts of its automated system.

In system 500, a third party media provider 515 in communication with the marketplace operator 502 and its automated system 510 handles the direct delivery of advertisements to the user. For example, the third party media provider 515 could be a high-capacity provider who specializes in the delivery of high bandwidth items, like video. When the advertisement is to be presented to the user, the marketplace operator 502 could seamlessly and, if desired, invisibly direct the user 406 to an automated system belonging to the third party media provider 515 for viewing of the advertisement.

In some embodiments, the third party media provider 515 could be a cable or television programming company, and advertisements could be presented to the user using a television set, with a set-top box or elements within the television set controlling the presentation of the advertisements. If the users 406 are presented with advertisements using a television set, they may answer questions related to the advertisements using another type of personal computing device. In general, a user need not view the advertisements and answer questions or perform other interactive tasks using the same device. For example, a user 406 could use a cellular telephone (voice call, text messaging, etc.) or a personal computer, either contemporaneously or at a later time, to answer questions about the advertisement or to perform any other action necessary in system 500. Compensation in the above example may be in the form of credits to the user's cable or cellular telephone bill.

A third party payor 513 handles the payment task similarly, with appropriate instructions on how much compensation with to provide each user 406 from the marketplace operator 502. For example, when a user has earned compensation, the automated system 510 of the marketplace operator 502 could signal the third party payor 513 to compensate the user 406. This may be done by providing the third party payor 513 with lists of users 406 and corresponding compensation amounts at regular intervals.

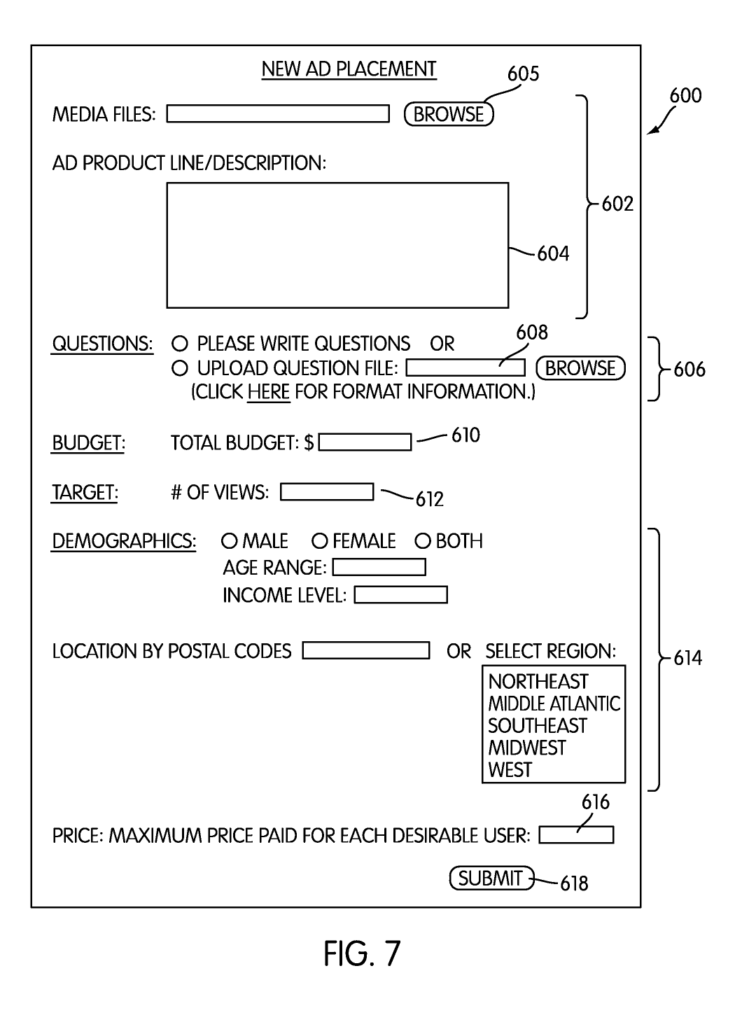

As was described above, marketers 404 may use an interactive interface to communicate with the marketplace operator 402, 502 for advertisement placement or to obtain progress reports, statistics, and other information about their advertisement campaigns. FIG. 7 is an illustration of a new advertisement placement screen 600 that may be used by a marketer 404 to place an advertisement or to create a new advertisement campaign. Screen 600 may be delivered to the marketer 404 through the Internet or encapsulated as part of a software package on the marketer's automated systems. The answers given may be transmitted back to the marketplace operator 402, 502 automatically, or they may be printed and sent in hardcopy format along with storage media having the advertisements stored in electronic form.

Screen 600 provides for the uploading of the media files that constitute the actual advertisement, as well as the uploading or inputting of questions, and the designation of a budget, of desirable users, and of the marketer's maximum supply price. Specifically, input area 602 allows the marketer to designate one or more media files that are to be played as the advertisement. The browse button 603 in input area 602 allows the marketer 404 to open a dialog box to select the files from the marketer's system. A script may be used to check and ensure that the files designated by the marketer 404 are in a data format acceptable to the marketplace operator 402, 502. Description area 604 gives the marketer 404 an opportunity to provide a description that may be used by the marketplace operator 402, 502 or presented to the users 406, depending on the embodiment.

Question area 606 of screen 600 allows the marketer 404 to choose between asking the marketplace operator 402, 502 to prepare appropriate questions and providing questions for the marketplace operator 402, 502 to use. In general, if a marketer 404 provides questions for a marketplace operator 402, 502, those questions may be provided in a designated format understood by the automated systems 410, 510 of the marketplace operator 402, 502. Question area 606 provides a question file designation area, where a marketer 404 may designate a question file to be uploaded to the marketplace operator 402, 502. Questions may be provided to the marketplace operator 402, 502, for example, in HTML or XML formats, and another script may be used to verify that the questions are in the correct format before accepting the file.

In budget area 610, the marketer 404 may specify a total budget for the advertisement campaign, and in target area 612, the marketer 404 may specify the number of views it is seeking for a particular advertisement. Demographic specification area 614 of screen 600 allows the marketer 404 to specify desirable user attributes, and supply price specification area 616 allows the marketer 404 to specify the maximum price to be paid for reaching each of the most desirable users. Finally, submit button 618 provides a mechanism to submit the provided information to the marketplace operator 402, 502. When the submit button is activated, the scripts described above, and any other scripts or programs, may be run to confirm the acceptability of the information that is provided.

Using screen 600, and in accordance with the description above, it is not necessary for the marketer 404 to answer all of the questions posed on screen 600. For example, an advertiser could simply specify a total budget in budget area 610 and then leave the marketplace operator 402, 502 to specify some or all of the user attributes. Additionally, if a marketer 404 gives particular answers on screen 600, they could be asked additional questions on following screens.

Screen 600 is one example of the type of interactive interface that may be used. Depending on the embodiment, a marketer 404 may be given the opportunity to give a variety of directions and targeting information for each advertisement.

In the description above, particularly the description of method 10, the user affirmatively specifies an attention price, either in a free-form manner by filling in a blank or by choosing between alternatives offered by the marketplace operator 402, 502. However, in either of those two scenarios, the user is aware that he or she is specifying an attention price. However, the attention price could be determined in large part by the marketplace operator 402, 502 alone or in collaboration with the marketer 404. In that case, the user may choose whether or not to view an advertisement at the specified attention price. If the user chooses not to view an advertisement or a group of advertisements at a particular price, that choice reflects the user's attention price, and is taken into account in pricing advertisements for that user in the future.

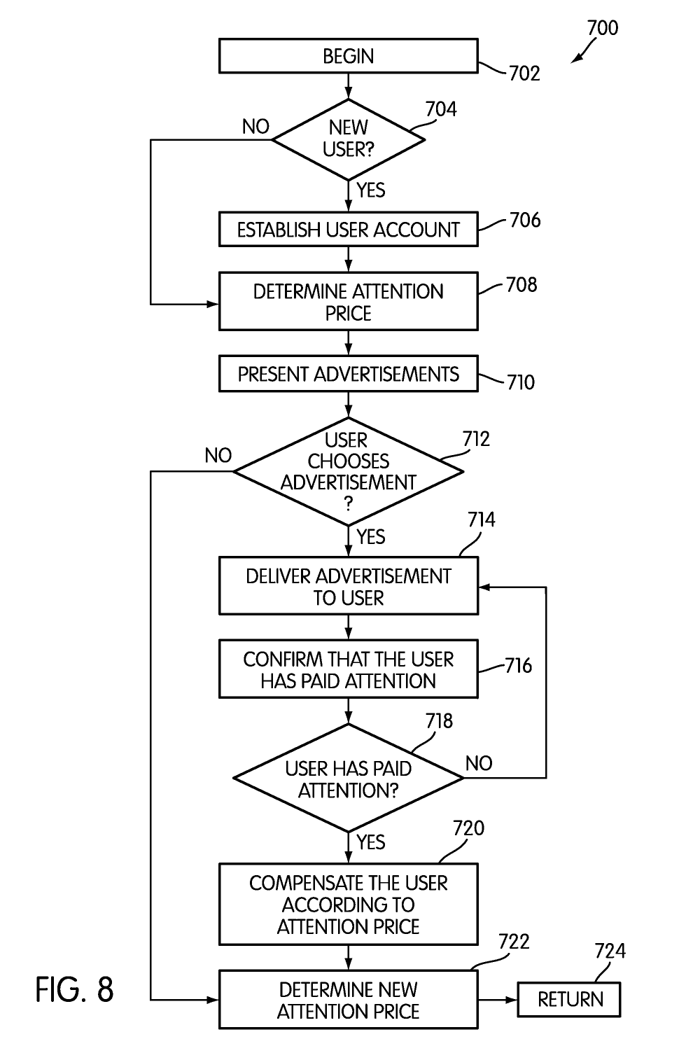

FIG. 8 is a flow diagram of a method 700. Method 700 is a method for creating and maintaining an attention marketplace in which the attention price is determined, rather than specified by the user. Unless otherwise indicated, the disclosure above relating to method 10 and systems 400 and 500 is applicable to method 700. Method 700 begins at 702, and tasks 704 and 706 are substantially the same as tasks 14 and 16 of method 10.

Method 700 continues with task 708. In task 708, an attention price is determined. In method 700, the attention price is determined, at least in part, by market forces and factors. That is, the particular attention price may be different for each user, and may be determined by the particular brand that is being advertised, the length of the advertisement, the timing or time of delivery of the advertisement, and the attributes of the users to whom the advertisement is targeted, among other factors. Users who are more desirable to a particular marketer would generally be offered a higher attention price. Typically, marketers 404 would seek to pay the least amount possible for user attention.

Once an attention price is determined for a user in task 708, method 700 continues with task 710, in which the user is presented with one or more advertisements for possible viewing. Task 710 of method 700 may be accomplished in much the same way as task 18 of method 10. For example, screens like screen 100 and screen 200 may be used, presented through a World Wide Web browser. However, in method 700, the user may be given only one compensation option, as in “Car Brand X” and “Car Brand Y” of screen 200; the fact that an attention price has been determined for that particular user might not be directly revealed to the user.

Once the user has been presented with an advertisement or multiple advertisements for possible viewing, method 700 continues with task 712, a decision task. Once presented with advertisements, the user is given the choice of whether or not to view those advertisements at the determined attention price. If the user decides to view the advertisements at the determined attention price (task 712:YES), method 700 continues with tasks 714-720, which are performed in the same manner as tasks 26-32 of method 10 so that the advertisements are delivered to the user and the user is compensated according to the attention price. Additionally, the user may be asked behavioral or profile questions, as in task 24 of method 10.

If the user does not choose to view the advertisements at the determined attention price (task 712:NO), and at the conclusion of task 720, method 700 continues with task 722, in which a new attention price is determined.

When a user refuses to view an advertisement at a given attention price, that behavior could indicate one of several things. For example, a user's refusal to view an advertisement at a particular attention price could indicate that the user considers the attention price to be too low. In that case, the marketplace operator may increase the attention price by some amount. A user's refusal to view an advertisement could also indicate that the subject matter of the advertisement is not of interest to the user. In that case, the marketplace operator could present different advertisements to the user the next time that particular user participates in method 700, or the marketplace operator could take that particular user's behavior as indicative of group behavior and present different advertisements to an entire group of users. When determining a new attention price, both an individual user's actions and the actions of a group of users may be taken into account.

As one example, assume that a user is a male of legal drinking age, and he is given the opportunity to view a 30-second video advertisement for a new light beer and offered $0.50 for his attention. The user refuses to view the advertisement. In response, the marketplace operator decides that the new attention price for that user for light beer commercials should be $1.00, and offers to allow the user to view the advertisement at that new attention price. The user accepts.

As another example, assume that the user of the above example refuses to view the light beer advertisement for $0.50. In response, the marketplace operator decides that the new attention price should be the same as the original attention price, but does not offer to allow the user to view the advertisement, or others like it, again.

In a third example, assume that the user of the above examples and a number of other users have all declined to view an advertisement at the first offered attention price. Also assume that they have declined to view the advertisement at higher new attention prices. The marketplace operator may use that data to conclude that those users are not interested in light beer advertisements, and could offer only regular or microbrew beer advertisements to those users, or no beer advertisements at all.

As the above examples illustrate, determining the new attention price in task 722 of method 700 involves a number of factors and could result in a number of outcomes. The new attention price could be higher, the same, or lower than the original attention price. Additionally, the user may or may not be permitted to view that same advertisement at a higher new attention price. Generally, the decision of whether to allow a user to view the same advertisement in exchange for a higher attention price would be balanced against user tendencies to refuse to view advertisements at the original low attention price in hopes of being offered a higher price. If the user knows that if he or she refuses to view an advertisement at a lower attention price, he or she will be offered a higher price, then the user will generally not be motivated to accept the lower price.

The actual new attention price offered to the user would depend on the available budget for the advertisement, on the desirability of the user to the marketer, on whether or not the user has purchased products for which he or she has viewed advertisements, and on the behavior of other users to the attention prices that have been offered to view that same advertisement, among other factors.

As shown in FIG. 8, once the new attention price is determined in task 722, method 700 concludes at task 724. However, as was set forth above in the various examples, the task of determining the new attention price may be coupled to or followed by various other tasks. Additionally, an attention marketplace in which the attention price is determined for the user may incorporate any other features disclosed in this specification, and, in some embodiments, the method of determining an attention price for the user may be used alongside an embodiment in which the user is permitted to specify attention prices for some advertisements.

In the embodiments described above, the operator of the attention marketplace offered the advertisements to the users, either directly or through a third party. However, other embodiments of the invention may be tailored to work with conventional broadcast advertising that is not explicitly delivered by or under the direct auspices of the marketplace operator.

In a broadcast advertisement environment, advertisements would be broadcast by traditional means (e.g., television, radio, print, or World Wide Web) with a tag that alerts the viewer that compensation is available through the attention marketplace operator if the user goes to a particular website or takes some further action.

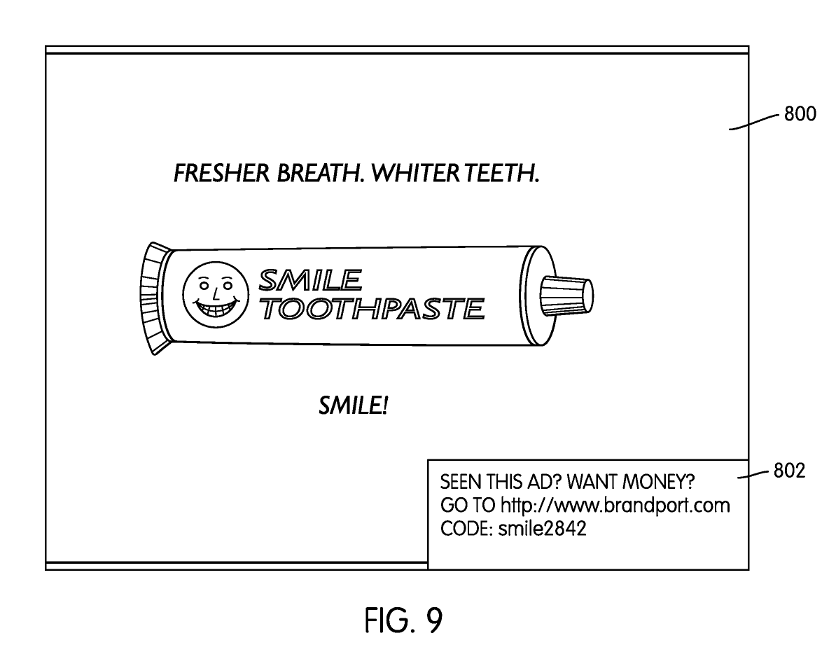

For example, FIG. 9 is an illustration of an exemplary advertisement 800 with a tag 802 that alerts users that compensation is available. The advertisement 800 is for a particular brand of toothpaste, and the tag 802 is positioned in the lower right hand corner of the advertisement 800 and is arranged to be noticeable without overwhelming and taking away from the message of the advertisement 800 itself. The tag 802 informs the viewer, “Seen this ad? Want money? Go to http://www.brandport.com.” The tag 802 also includes a code, in this case “smile2842” that is recognizable to the attention marketplace operator.

Typically, the user would note any code that is provided and would follow the instructions provided by the tag 802. The resulting sequence of tasks and events would be much like the flow of tasks in methods 10 and 700. After establishing an account and/or logging in, the user would be permitted to enter the code to identify the advertisement that he or she had seen. An attention price would be determined for or specified by the user, and, in most embodiments, if the user answered questions or otherwise confirmed that he or she had really paid attention to the advertisement, he or she would be compensated according to the attention price. This broadcast method may be combined with or used concurrently with methods 10 and 700, and, as was noted above, either method may be used to set the attention price that the user is paid for their attention to the advertisement.

In advertisement 800, the tag 802 is text-based and provides a relatively complete set of information on what to do to receive compensation for viewing the advertisement 800. Tag 802 is, in effect, an advertisement itself—an advertisement for the attention marketplace. A tag like tag 802 is particularly suitable for print advertisements and for other media in which user interaction is not possible; it provides all the necessary information. However, in other embodiments, a “tag” may be any element of an advertisement or any element associated with an advertisement that indicates the possibility of being compensated for viewing or paying attention to the advertisement. If the advertisement is offered as a banner advertisement through the World Wide Web or another such network, the tag could be a text link or a graphical portion of the advertisement that, when clicked, leads the user directly to the attention marketplace. If the advertisement is an audio advertisement, the tag may be a spoken-word indication or set of instructions delivered with the advertisement.

In yet another embodiment, the tag may simply be a graphic, logo, or word associated with the attention marketplace, without a code or other specific identifier for that particular advertisement. Without a code, the user would then log into the attention marketplace, would be presented with a list of advertisements that have been broadcast, and would choose the advertisement that he or she had seen broadcast, much in the same way that methods 10 and 700 use screens 100 and 200 for advertisement selection. However, instead of then delivering the advertisement to the user for viewing, the automated system would proceed with confirming that the user had paid attention to the advertisement, generally by presenting a set of questions. If the user successfully answers the questions, he or she would then be compensated according to whatever attention price had been determined or specified. If the user does not successfully answer the questions, the marketplace operator may present the user with the advertisement again, much as in methods 10 and 700 and, as described above with respect to those methods, the user may earn less compensation.

In some embodiments, users who are exposed to a broadcast advertisement and then take the time to go to the attention marketplace and seek compensation for the advertisement may be permitted to specify or given higher attention prices and, thus, higher compensation, because noting the advertisement and taking the time to go to the attention marketplace may be considered by some marketers to be positive user behaviors worthy of higher compensation.

Broadcast advertising tied to an attention marketplace may also be used with receipt tickets 250 and other similar technologies in order to fully integrate the attention marketplace, broadcast advertising, and the brick-and-mortar world.

Although the invention has been described with respect to certain embodiments, those embodiments are intended to be exemplary, rather than limiting. Modifications and changes may be made within the scope of the invention, which is determined by the claims.

1. A method of advertising, comprising:
allowing a user to specify an attention price for paying attention to one or more advertisements;
presenting the one or more advertisements to the user; and
providing the user with compensation according to the attention price.

2. The method of claim 1, further comprising:
confirming that the user has paid attention to the one or more advertisements; and
providing the user with the compensation according to the attention price if the user has paid attention to the one or more advertisements.

3. The method of claim 2, wherein the confirming comprises
presenting the user with one or more questions related to the one or more advertisements; and
checking whether at least some of the user's answers to the one or more questions are correct.

4. The method of claim 3, wherein the compensation is equal to or greater than the attention price if the user answers all of the one or more questions correctly.

5. The method of claim 4, wherein the compensation is less than the attention price if the user does not answer all of the one or more questions correctly.

6. The method of claim 1, wherein the compensation is monetary compensation.

7. The method of claim 1, wherein the compensation is promotional compensation.

8. Machine-readable instructions on a machine-readable medium interoperable with a machine to perform the method of claim 1.

9. A method of advertising, comprising:
determining an attention price for a user;
allowing the user to choose whether or not to view one or more advertisements in exchange for compensation according to the attention price;
if the user chooses to view the one or more advertisements,
presenting the one or more advertisements to the user, and
providing the user with compensation according to the attention price; and
determining a new attention price based, at least in part, on whether or not the user chose to view the one or more advertisements in exchange for compensation according to the attention price.

10. The method of claim 9, wherein the compensation is selected from the group consisting of monetary compensation, promotional compensation, and a combination of monetary and promotional compensation.

11. The method of claim 9, further comprising:
confirming that the user has paid attention to the one or more advertisements; and
providing the user with the compensation in accordance with the attention price if the user has paid attention to the one or more advertisements.

12. The method of claim 11, wherein confirming that the user has paid attention to the one or more advertisements comprises presenting the user with questions related to the one or more advertisements and checking the user's answers to the questions.

13. The method of claim 9, wherein the attention price is based, at least in part, on characteristics selected from the group consisting of brand, length of the one or more advertisements, timing of advertisement presentation, and target user attributes.

14. The method of claim 9, wherein the new attention price is the same as or less than the attention price.

15. The method of claim 9, further comprising
allowing the user to verify a positive user behavior with respect to a product or service related to the one or more advertisements; and
causing the new attention price to be higher than the attention price because of the positive user behavior.

16. Machine-readable instructions on a machine-readable medium interoperable with a machine to perform the method of claim 9.

17. An advertising system, comprising:
an account module that collects user attributes and establishes user accounts;
a marketplace module that presents at least one appropriate advertisement and allows a user to specify the attention price for viewing the at least one appropriate advertisement;
a delivery module that delivers the advertisement to the user; and
a payment module that compensates the user for paying attention to the advertisement according to the attention price.

18. The advertising system of claim 17, wherein the delivery module verifies that the user has paid attention to the advertisement by asking the user questions and verifying the user's answers to the questions.

19. The advertising system of claim 17, wherein the marketplace module allows a marketer to specify a supply price that the marketer is willing to pay for user attention and at least one desirable user attribute.

20. The advertising system of claim 19, wherein the marketplace module matches the supply price and the at least one desirable user attribute with the attention price and the user attributes to determine which of a plurality of available advertisements comprise the appropriate advertisement for the user.

21. A method of advertising, comprising:
broadcasting an advertisement to one or more users, and, for at least one of the one or more users,
determining an attention price or allowing the user to specify the attention price;
confirming that the user has paid attention to the advertisement; and
if the user has paid attention to the advertisement, compensating the user according to the attention price.

22. The method of claim 21, wherein the advertisement includes a tag indicating that compensation is available in connection with the advertisement.

23. The method of claim 22, wherein the tag further comprises a set of instructions indicating what to do to receive compensation.

24. The method of claim 23, wherein the tag provides a code.

25. The method of claim 24, wherein confirming that the user has paid attention comprises verifying that a code supplied by the user is the code provided by the tag.

26. The method of claim 22, wherein the tag comprises a link that can be followed in order to receive compensation.

27. The method of claim 21, wherein the broadcasting comprises broadcasting in one or more media selected from the group consisting of television, radio, print, personal computing device, and World Wide Web.

28. The method of claim 21, wherein confirming that the user has paid attention comprises asking the user one or more questions about the advertisement and confirming that at least some answers given by the user in response to the one or more questions are correct.
